(19) United States
(12) Patent Application Publication
(10) Pub. No.: US 2021/0323015 A1
(43) Pub. Date: Oct. 21, 2021

(54) SYSTEM AND METHOD TO MONITOR NOZZLE SPRAY QUALITY

(71) Applicant: CNH Industrial Canada, Ltd., Saskatoon (CA)

(72) Inventors: Andrew W. Harmon, Sheboygan, WI (US); Trevor Stanhope, Palos Hills, IL (US); Roy A. Bittner, Cato, WI (US); Jason Hardy, Saskatoon (CA)

(73) Assignee: CNH Industrial Canada, Ltd.

(21) Appl. No.: 17/227,699

(22) Filed: Apr. 12, 2021

Related U.S. Application Data
(60) Provisional application No. 63/011,588, filed on Apr. 17, 2020.

(51) Int. Cl. B05B 12/08; B05B 1/20; B05B 12/12; A01C 23/04; A01M 7/00; A01C 23/00

(52) U.S. Cl. CPC B05B 12/082; B05B 1/20; B05B 12/122; A01M 7/0089; A01M 7/0042; A01C 23/007; A01C 23/047

(57) ABSTRACT

A system for monitoring spray quality of an agricultural vehicle is provided herein that includes a boom assembly and a nozzle positioned along the boom assembly. A flow regulator is operably coupled with the nozzle and is configured to control a flow of agricultural product through the nozzle. A sensor is configured to capture data indicative of a spray exhausted from the nozzle. A spray quality controller is communicatively coupled to the sensor. The controller is configured to receive flow data from the flow regulator indicative of a demanded application rate; receive the captured data from the sensor as the agricultural vehicle travels across the field; and generate a malfunction notification when the flow data from the flow regulator indicates a flow to the nozzle and the captured data from the sensor indicates a lack of spray from the nozzle.

### CROSS-REFERENCE TO RELATED APPLICATION

This application is a non-provisional application claiming the benefit of priority under 35 U.S.C. § 119(e) to U.S. Provisional Application No. 63/011,588, filed Apr. 17, 2020, which is hereby incorporated by reference in its entirety.

### FIELD

The present disclosure generally relates to agricultural implements and, more particularly, to systems and methods for monitoring nozzle spray quality of an agricultural product during a spray operation, such as by monitoring one or more spray quality parameters during the spray operation.

### BACKGROUND

Various types of work vehicles utilize applicators (e.g., sprayers, floaters, etc.) to deliver an agricultural product to a ground surface of a field. The agricultural product may be in the form of a solution or mixture, with a carrier (such as water) being mixed with one or more active ingredients (such as an herbicide, fertilizer, fungicide, a pesticide, or another product).

The applicators may be pulled as an implement or self-propelled, and can include a tank, a pump, a boom assembly, and a plurality of nozzles carried by the boom assembly at spaced locations. The boom assembly can include a pair of boom arms, with each boom arm extending to either side of the applicator when in an unfolded state. Each boom arm may include multiple boom sections, each with a number of spray nozzles (also sometimes referred to as spray tips).

The spray nozzles on the boom assembly disperse the agricultural product carried by the applicator onto a field. During a spray operation, however, various factors may affect a quality of application of the agricultural product to the field. Accordingly, an improved system and method for monitoring the quality of application of the agricultural product to the field would be welcomed in the technology.

### BRIEF DESCRIPTION

Aspects and advantages of the technology will be set forth in part in the following description, or may be obvious from the description, or may be learned through practice of the technology.

In some aspects, a system for monitoring spray quality of an agricultural vehicle is disclosed that includes a boom assembly and a nozzle positioned along the boom assembly. A flow regulator can be operably coupled with the nozzle and can be configured to control a flow of agricultural product through the nozzle. A sensor can be configured to capture data indicative of a spray exhausted from the nozzle. A spray quality controller can be communicatively coupled to the sensor. The controller can be configured to receive flow data from the flow regulator indicative of a demanded application rate; receive the captured data from the sensor as the agricultural vehicle travels across the field; and generate a malfunction notification when the flow data from the flow regulator indicates a flow to the nozzle and the captured data from the sensor indicates a lack of spray from the nozzle.

In some aspects, a boom assembly is disclosed that includes a frame and a boom arm coupled to the frame. First and second nozzles can be positioned along the boom arm. Each of the first and second nozzles can be configured to dispense a fan of an agricultural product therefrom. A first sensor can be configured to capture data indicative of a spray quality associated with the dispensed fan of the first nozzle. A second sensor can be configured to capture data indicative of a spray quality associated with the dispensed fan of the second nozzle. A first spray quality controller can be operably coupled with the first sensor and configured to calculate a first nozzle spray quality. A second spray quality controller can be operably coupled with the second sensor and configured to calculate a second nozzle spray quality. The first and second nozzle spray qualities are independently communicated to a vehicle controller.

In some aspects, a method for monitoring an agricultural product during a spray operation is disclosed. The method can include receiving data from a first sensor that is indicative of a spray quality of a fan of agricultural product from a first nozzle. The method can also include receiving data from a second sensor that is indicative of a spray quality of a fan of agricultural product from a second nozzle. In addition, the method can include receiving flow data from first and second flow regulators respectively coupled with the first and second nozzles. Further, the method includes monitoring the spray quality associated with each of the first and second nozzles based on the data received from the respective first and second sensors and the flow data. Lastly, the method can include generating a malfunction notification when an anticipated spray quality based on the flow data is greater than a detected spray quality based on the data received from the first or second sensor.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of some embodiments of a work vehicle in accordance with aspects of the present subject matter;

FIG. 2 illustrates a side view of the work vehicle in accordance with aspects of the present subject matter;

FIG. 3 is an enhanced view of section III of FIG. 1 illustrating a rear view of a portion of a boom assembly in accordance with aspects of the present subject matter;

FIG. 4 illustrates a block diagram of components of the agricultural applicator system in accordance with aspects of the present subject matter; and

FIG. 5 illustrates a flow diagram of some embodiments of a method for monitoring an agricultural product during a spray operation of an agricultural product in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of some embodiments can be used with another embodiment to yield a still further embodiment. Thus, it is intended that the present invention covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to systems and methods for monitoring various nozzles while dispensing an agricultural product, such as by monitoring one or more spray quality parameters. In several embodiments, a boom assembly may be configured to couple with a work vehicle. The vehicle and/or the boom assembly includes a plurality of spray nozzles that disperse an agricultural product onto a field. During a spray operation, various spray quality parameters may affect a spray quality of application of the agricultural product to the field. The spray quality can be defined as a predefined application rate/range that estimates whether a spray operation has led to appropriate coverage of a field, or a portion of the field, by the agricultural product based on a summation of the monitored spray quality parameters. In some instances, the spray quality can be a scaled integer based on the deviations of each parameter from an optimal threshold or range defined between an upper threshold and a lower threshold for that respective parameter to determine whether the agricultural product was appropriately applied or misapplied to various portions of the field.

In several embodiments, the one or more spray quality parameters that may affect the spray quality can include at least one of a nozzle tip size and style, which agricultural product is being applied, an incorrect agricultural product application rate, inclement weather as determined by meeting one or more criteria, an agricultural product application rate or pressure deviating from a predefined range, boom assembly movement (e.g., jounce) deviating from a movement range, a vehicle deviating from a predefined speed, a vehicle acceleration/deceleration deviating from a predefined range, a turning radius deviating from predefined criteria, and/or any other variable.

In several embodiments, to monitor the spray quality parameters, one or more sensors may be operably coupled with each of the nozzles. The sensors may each be coupled to an independent spray quality controller. Each spray quality controller may be capable of calculating a spray quality for the nozzle that it receives data from through the sensor. In some instances, additional information is provided to each spray quality controller, which may include information such as a demanded application rate for the nozzle and/or any other information. A vehicle controller is communicatively coupled to the spray quality controllers and/or the sensors and includes a processor and associated memory. The memory can store instructions that, when implemented by the processor, configure the controller to store the each spray quality at geo-located vehicle positions, calculate an overall spray quality for various portions of the field, map the spray quality over a corresponding field map, and/or generate a notification when any of the spray quality parameters deviate from a predefined range and/or from a demanded application rate.

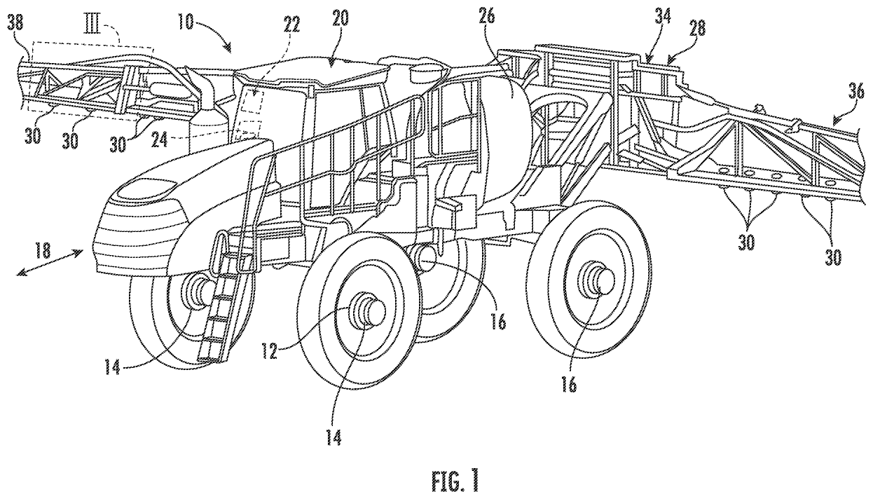

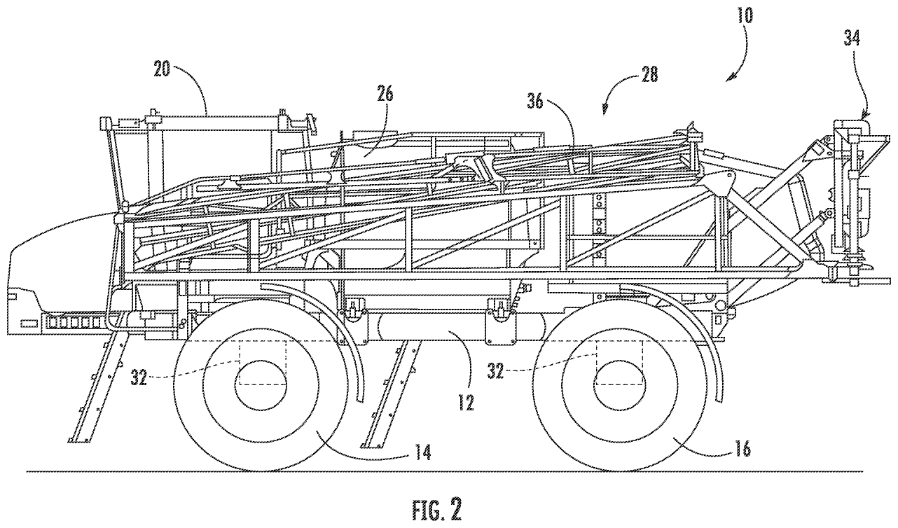

Referring now to FIGS. 1 and 2, a work vehicle 10 is generally illustrated as a self-propelled agricultural applicator. However, in alternate embodiments, the work vehicle 10 may be configured as any other suitable type of work vehicle 10 configured to perform agricultural spray operations, such as a tractor or other vehicle configured to haul or tow an application implement.

In various embodiments, the work vehicle 10 may include a chassis 12 configured to support or couple to a plurality of components. For example, front and rear wheels 14, 16 may be coupled to the chassis 12. The wheels 14, 16 may be configured to support the work vehicle 10 relative to a ground surface and move the work vehicle 10 in a direction of travel (e.g., as indicated by arrow 18 in FIG. 1) across a field or a ground surface. In this regard, the work vehicle 10 may include a power plant, such as an engine, a motor, or a hybrid engine-motor combination, to move the vehicle 10 along a field.

The chassis 12 may also support a cab 20, or any other form of operator's station for permitting the operator to control the operation of the work vehicle 10. For instance, as shown in FIG. 1, the work vehicle 10 may include a human-machine interface (HMI) 22 for displaying messages and/or alerts to the operator and/or for allowing the operator to interface with the vehicle's controller through one or more user input devices 24 (e.g., levers, pedals, control panels, buttons, and/or the like).

The chassis 12 may also support one or more tanks, such as a rinse tank and/or a product tank 26, and a boom assembly 28 mounted to the chassis 12. The product tank 26 is generally configured to store or hold an agricultural product, such as a pesticide, a fungicide, a rodenticide, a fertilizer, a nutrient, and/or the like. The agricultural product is conveyed from the product tank 26 through plumbing components, such as interconnected pieces of tubing, for release onto the underlying field (e.g., plants and/or soil) through one or more nozzles 30 mounted on the boom assembly 28. In some embodiments, to improve the agricultural product application quality and/or operator comfort, the vehicle 10 can be equipped with a passive, semi-active, or active vehicle suspension 32 to dampen movement of the vehicle 10 and/or the boom assembly 28 while operating the vehicle 10 and/or the boom assembly 28.

As shown in FIGS. 1 and 2, the boom assembly 28 can include a frame 34 that supports first and second boom arms 36, 38, which may be orientated in a cantilevered nature. The first and second boom arms 36, 38 are generally movable between an operative or unfolded position (FIG. 1) and an inoperative or folded position (FIG. 2). When distributing product, the first and/or second boom arm 36, 38 extends laterally outward from the work vehicle 10 to cover wide swaths of the underlying ground surface, as illustrated in FIG. 1. However, to facilitate transport, each boom arm 36, 38 of the boom assembly 28 may be independently folded forwardly or rearwardly into the inoperative position, thereby reducing the overall width of the vehicle 10, or in some examples, the overall width of a towable implement when the applicator is configured to be towed behind the work vehicle 10.

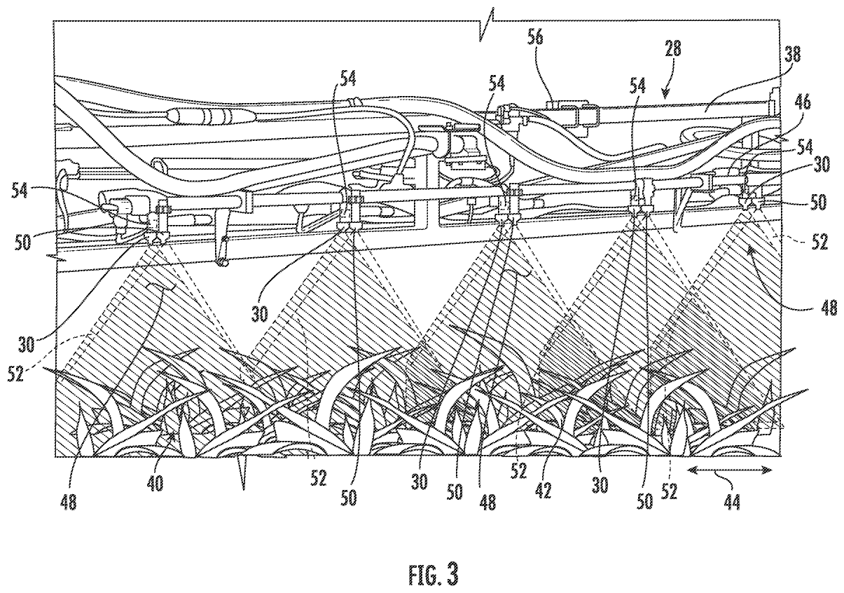

Referring to FIG. 3, the boom assembly 28 may be configured to support a plurality of nozzles 30. Each nozzle 30 may, in turn, be configured to dispense the agricultural product stored within the tank 26 (FIG. 1) onto the underlying field 40 and/or plants 42. In several embodiments, the nozzles 30 may be mounted on and/or coupled to the first and/or second boom arms 36, 38 of the boom assembly 28, with the nozzles 30 being spaced apart from each other along a lateral direction 44. Furthermore, fluid conduits 46 may fluidly couple the nozzles 30 to the tank 26. In this respect, as the sprayer 10 travels across the field 40 in the direction of travel 14 to perform a spraying operation thereon, the agricultural product moves from the tank 26 through the fluid conduit(s) 58 to each of the nozzles 30. The nozzles 30 may, in turn, dispense or otherwise spray a fan 48 of the agricultural product onto the underlying field 40 and/or plants 42. For example, in one embodiment, the nozzles 30 may correspond to flat fan nozzles configured to dispense a flat fan 48 of the agricultural product. However, in alternative embodiments, the nozzles 30 may correspond to any other suitable types of nozzles, such as dual pattern nozzles and/or hollow cone nozzles.

In accordance with aspects of the present subject matter, one or more spray quality sensors 50 may be installed on the vehicle 10 and/or the boom assembly 28. In general, the spray quality sensors 50 may be configured to capture data indicative of one or more spray quality parameters associated with the fans 48 of the agricultural product being dispensed by the nozzles 30. The spray quality parameter(s) may, in turn, be indicative of the quality of the spraying operation, such as whether a target application rate of the agricultural product is being met.

In several embodiments, the spray quality sensors 50 may correspond to one or more imaging devices. In such embodiments, each imaging device may be coupled to or mounted on the boom assembly 28 such that the one or more fans 48 of the agricultural product are positioned within an associated field of view 52. As such, each imaging device may be configured to capture image data related to the one or more spray fans 48. As will be described below, a spray quality controller 74a, 74b may be configured to analyze the image data to determine one or more spray fan parameters of the depicted spray fans 48. For example, such spray fan parameters may include the shape of the spray fans 48, the size or width of the spray fans 48, the height of the spray fans 48, the size of the droplets/particles forming the spray fans 48, and/or an inconsistency in such parameters between two or more spray fans 48. In the illustrated embodiment, a single imaging device is installed on the boom assembly 28, with a single spray fan 48 positioned within its field of view 52. However, in alternative embodiments, any other suitable number of imaging devices may be installed on the boom assembly 28. Furthermore, any other suitable number of spray fans 48 may be positioned the field of view 52 of each imaging device.

The imaging device(s) may correspond to any suitable sensing device(s) configured to detect or capture images or other image-like data associated with the spray fans 48 present within its field of view 52. For example, in several embodiments, the imaging device(s) may correspond to a suitable camera(s) configured to capture three-dimensional images of the spray fans 48 present within its field of view 52. For instance, in a particular embodiment, the imaging device(s) may correspond to a stereographic camera(s) having two or more lenses with a separate image sensor for each lens to allow the camera(s) to capture stereographic or three-dimensional images. However, in alternative embodiments, the imaging device(s) may correspond to any other suitable sensing device(s) configured to capture image or image-like data, such as a monocular camera(s), a LIDAR sensors, and/or a RADAR sensors.

In another embodiment, the spray quality sensors 50 may correspond to one or more pressure sensors 54. In general, the pressure sensors 54 may be configured to capture data indicative of the pressure of the agricultural product being supplied to the nozzles 30. As such, the pressure sensors 54 may be provided in fluid communication with one of the fluid conduits 46. For example, the pressure sensor 54 may correspond to a diaphragm pressure sensor, a piston pressure sensor, a strain gauge-based pressure sensor, an electromagnetic pressure sensor, and/or the like.

In a further embodiment, the spray quality sensors 50 may correspond to one or more airspeed sensors 56. In general, the airspeed sensors 56 may be configured to capture data indicative of the airspeed of the air flowing past the boom assembly 28 as the sprayer 10 travels in the direction of travel 14. The airspeed data may, in turn, be indicative of the speed at which the air moves relative the boom assembly 28. In this respect, airspeed data may take in account both the airflow caused by the movement of the sprayer 10 relative to the ground and the airflow caused by any wind that is present. For example, the airspeed sensors 56 may correspond to a pitot tube, an anemometer, and/or the like. As shown, the airspeed sensors 56 are mounted on the top of the boom assembly 28. However, in alternative embodiments, the airspeed sensors 56 may be installed on the sprayer 10 at any other suitable location(s). Moreover, in further embodiments, the spray quality sensors 50 may correspond to any other suitable sensors capable of capturing data indicative of the quality of the spray fans 48 emitted by the nozzles 30.

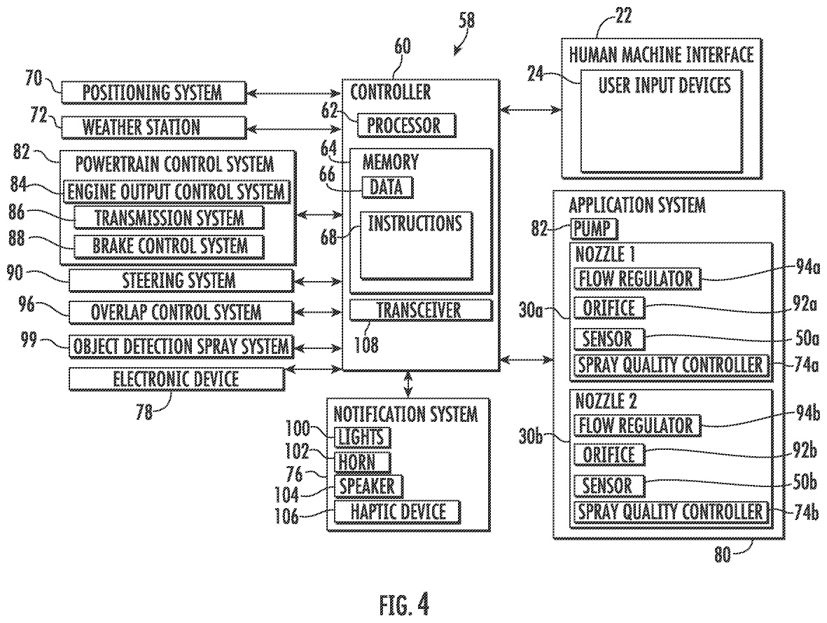

Referring now to FIG. 4, a schematic view of some embodiments of a system 58 for monitoring an agricultural product during a spray operation is illustrated in accordance with aspects of the present subject matter. In general, the system 58 will be described herein with reference to the work vehicle 10 and the boom assembly 28 described above with reference to FIGS. 1-3. However, it should be appreciated that the disclosed system 58 may generally be utilized with work vehicles 10 having any suitable vehicle configuration and/or implements having any suitable implement configuration.

In several embodiments, the system 58 may include a vehicle controller 60 that is commutatively coupled with one or more nozzles 30a, 30b. Each of the nozzles 30a, 30b may define an orifice 92a, 92b through which a fan 48 of agricultural product is generated. A sensor is configured to monitor the fan 48 of agricultural product and provides data related thereto. The data can be processed and monitored by independent spray quality controllers 74a, 74b that are related to each nozzle 30a, 30b. The spray quality calculated by each spray quality controller 74a, 74b may be communicated to the vehicle controller 60. For some spray operations, one or more spray quality parameters are generally optimized to reduce application overlap, under application, or over application during the spray operation. Accordingly, a deviation of a single spray quality parameter from a desired condition or range can cause the agricultural product to be improperly applied to the field 40. Thus, to mitigate misapplications of an agricultural product during a spray operation, the vehicle controller 60 may store the spray quality at geo-located vehicle positions, map the spray quality over a corresponding field map, and/or generate a notification when the spray quality deviates from a predefined range and/or from the demanded application rate.

In general, the vehicle controller 60 may correspond to any suitable processor-based device(s), such as a computing device or any combination of computing devices. Thus, as shown in FIG. 4, the vehicle controller 60 may generally include one or more processors 62 and associated memory devices 64 configured to perform a variety of computer-implemented functions (e.g., performing the methods, steps, algorithms, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device 64 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory devices 64 may generally be configured to store information accessible to the processors 62, including data 66 that can be retrieved, manipulated, created and/or stored by the processors 62 and instructions 68 that can be executed by the processors 62.

In several embodiments, the data 66 may be stored in one or more databases. For example, the database may include a spray quality parameter database for storing spray quality parameter data received from one or more sensors for subsequent processing and/or analysis. Additionally, in several embodiments, the database may also include a location database storing location information about the work vehicle 10 and/or the boom assembly 28. Specifically, as shown in FIG. 4, the vehicle controller 60 may be communicatively coupled to a positioning system 70 installed on or within the work vehicle 10 and/or on or within the boom assembly 28. In some embodiments, the positioning system 70 may be configured to determine the location of the work vehicle 10 and/or the boom assembly 28 by using a GPS system, a Galileo positioning system, the Global Navigation satellite system (GLONASS), the BeiDou Satellite Navigation and Positioning system, a dead reckoning system, and/or the like. In such embodiments, the location determined by the positioning system 70 may be transmitted to the vehicle controller 60 (e.g., in the form location coordinates) and subsequently stored within the location database for subsequent processing and/or analysis. It should be appreciated that, in some embodiments, a first positioning system 70 may be provided on and/or within the work vehicle 10 while a separate, second positioning system 70 may be provided on and/or within the boom assembly 28.

In several embodiments, the location data stored within the location database may also be correlated to the spray quality parameter data stored within a spray quality parameter database. For instance, in some embodiments, the location coordinates derived from the positioning system 70 and the spray quality parameter data captured by the sensors 82 and/or a weather station 72 may both be time-stamped. In such embodiments, the time-stamped data may allow each individual set of data captured by the sensors 82 and/or the weather station 72 to be matched or correlated to a corresponding set of location coordinates received from the positioning system 70, thereby allowing the precise location of the portion of the field 40 associated with a given set of spray quality parameter data to be known (or at least capable of calculation) by the vehicle controller 60.

In some embodiments, the memory device 64 may include a field database for storing information related to the field 40, such as field map data. In such embodiments, by matching data to a corresponding set of location coordinates, the vehicle controller 60 may be configured to generate or update a corresponding field map associated with the field 40, which may then be stored within a field database for subsequent processing and/or analysis. For example, in instances in which the vehicle controller 60 includes a field map stored within the field database, the spray quality parameter data captured by the sensors 82, the positioning system 70, and/or the weather station 72 may be mapped or otherwise correlated to the corresponding locations within the field map.

In order to generate the spray quality, in some embodiments, the memory device 64 may also include an agricultural product database that stores product information. The product information may include various information regarding the optimal conditions and rates of application for an individual product that is to be applied to the field 40. In some instances, the product information may be preloaded or sent to the vehicle 10 via wired or wireless communication therewith. Additionally, or alternatively, the product information may be manually inputted into the database.

With further reference to FIG. 4, in several embodiments, the instructions 68 stored within the memory device 64 of the vehicle controller 60 may be executed by the processors 62 to analyze each spray quality generated by one or more spray quality controllers 74a, 74b, the positioning system 70, and/or the weather station 72. For instance, the processor 62 may be configured to execute one or more suitable data processing techniques or algorithms that allows the vehicle controller 60 to accurately and efficiently analyze the spray quality data from the one or more spray quality controllers 74a, 74b, the positioning system 70, and/or the weather station 72 to estimate the spray quality based on a combination of the various spray qualities along the boom assembly 28 for each respective nozzle 30a, 30b, and/or by performing any other desired data processing-related techniques or algorithms.

The vehicle controller 60 may also provide instructions for various other components communicatively coupled with the vehicle controller 60 based on the results of the data analysis. For example, the vehicle controller 60 may provide notification instructions to the vehicle notification system 76, the HMI 22, and/or a remote electronic device 78. The vehicle controller 60 may also be capable of altering a system or component of the vehicle 10 in response to one or more spray quality parameters deviating from a defined range or threshold. For instance, in some embodiments, the vehicle controller 60 may adjust an agricultural product application system 80 by altering an application rate of a product pump 81. Additionally, or alternatively, in some examples, the vehicle controller 60 may deactivate the pump 81 thereby pausing application of the agricultural product in response to determining that a spray quality of one or more nozzles 30a, 30b have deviated from a predefined range.

Referring still to FIG. 4, as provided herein, the vehicle 10 may include at least one mobile weather station 72 that can be mounted to the vehicle 10, the boom assembly 28, and/or other locations. The mobile weather station 72 can contain any sensors that are normally found on a stationary weather station that monitor one or more weather criteria, such as temperature, wind speed, wind direction, relative humidity, barometric pressure, cloud cover, and trends thereof. During operation, if one or more of the criteria changes, such as the wind direction or speed changes, the changes can reduce the ability to uniformly apply the agricultural product to the field 40. By using the information provided by the mobile weather station 72, the system 58 can determine when inclement weather exists for the spray operation. The determination of inclement weather may be based on a combination of the detected weather conditions in combination with the other spray quality parameters. For instance, when applying a smaller or finer agricultural product, a lower wind speed may lead to an incorrect application when compared to an agricultural product having a larger size. In such instances, the maximum wind speed allowed during application of the various products may differ. Likewise, any other weather criteria may also be altered based on the remaining spray quality parameters.

The vehicle controller 60 may also be operably coupled with a powertrain control system 82 that includes an engine output control system 84, a transmission control system 86, and a braking control system 88. Through the usage of any of these systems, the vehicle controller 60 may collect data related to one or more of the spray quality parameters, such as speed variations, steering variations, and/or terrain variations that may cause the boom assembly 28 to move from its neutral position. In some embodiments, the vehicle controller 60 may provide notifications if one or more of variables within the powertrain control system 82 either deviates from a predefined threshold or if the actions taken by the powertrain control system 82 contribute to a spray quality deviating from a predefined range and provide a mitigation action in response.

The engine output control system 84 is configured to vary the output of the engine to control the speed of the vehicle 10. For example, the engine output control system 84 may vary a throttle setting of the engine, a fuel/air mixture of the engine, a timing of the engine, and/or other suitable engine parameters to control engine output. In addition, the transmission control system 86 may adjust gear selection within a transmission to control the speed of the vehicle 10. Furthermore, the braking control system 88 may adjust braking force, thereby controlling the speed of the vehicle 10. While the illustrated powertrain control system 82 includes the engine output control system 84, the transmission control system 86, and the braking control system 88, it should be appreciated that alternative embodiments may include one or two of these systems, in any suitable combination. Further embodiments may include a powertrain control system 82 having other and/or additional systems to facilitate adjusting the speed of the vehicle 10.

Still referring to FIG. 4, a steering system 90 is configured to control a direction of the vehicle 10 through manipulation of one or more wheels 14, 16 (or tracks). The steering system 90 may include a steering system sensor to provide data related to an instantaneous steering direction of the vehicle 10 and/or a torque on the steering wheel 86 indicating an operator's intention for manipulating the steering system 90.

With further reference to FIG. 4, the vehicle controller 60 is operably coupled with an agricultural product application system 80 that may be configured to dispense a product from the product tank 26 to the field 40 through one or more nozzles 30a, 30b that is positioned at least partially along the boom assembly 28. As illustrated in FIG. 4, in some instances, the application system 80 can include first and second nozzles 30a, 30b. However, it will be appreciated that the application system 80 can include any number of nozzles 30a, 30b without departing from the scope of the present disclosure.

The first and second nozzles 30a, 30b each define an orifice 92a, 92b that may dispense a fan 48 of the agricultural product stored within the tank 26 onto the underlying field 40 and/or plants 42 at a target application rate. In general, the target application rate for an agricultural product is an amount (e.g., a volume or weight) of the substance to be applied per unit area of the field 40 (e.g., per acre) to provide the desired agricultural outcome (e.g., weed coverage reduction, pest reduction, and/or the like). In several embodiments, the application rate from the first nozzle 30a is controlled by a first flow regulator 94a and the application rate from the second nozzle 30b is controlled by a second flow regulator 94b. The first and second flow regulators 94a, 94b can be coupled to the pump 81 and include restrictive orifices, valves, and/or the like to regulate the flow of agricultural product from the product tank 26 to each orifice 92a, 92b. In various embodiments, the first and second flow regulators 94a, 94b may further include electronically controlled valves that are controlled by a Pulse Width Modulation (PWM) signal for altering the application rate of the agricultural product.

As described above, one or more spray quality sensors 50 are configured to capture data indicative of one or more spray quality parameters associated with one or more fans 48 of the agricultural product being dispensed by the boom assembly 28. In this regard, as the boom assembly 28 travels across the field 40 to perform the spraying operation thereon, respective spray quality controllers 74a, 74b within each nozzle 30a, 30b may be configured to receive the captured data from the spray quality sensors 50. Thereafter, the respective spray quality controllers 74a, 74b may be configured to process/analyze the received data to determine or estimate the spray quality parameter value(s) for each respective nozzle 30a, 30b. For instance, the respective spray quality controllers 74a, 74b may include a look-up table(s), suitable mathematical formula, and/or algorithms stored within its memory device 64 that correlates the received sensor data to the spray quality parameter value(s).

The determined spray quality parameter(s) may correspond to any suitable parameter(s)/characteristic(s) indicative of the quality of the spray fans 48 being dispensed by each nozzle 30a, 30b. For example, in several embodiments, the determined spray quality parameter(s) may correspond to one or more spray fan parameters. In several embodiments, the spray quality sensors 50 may include one or more imaging devices configured to capture image data depicting the spray fans 48 of one or more of the nozzles 30a, 30b of the boom assembly 28. In such embodiments, the respective spray quality controllers 74a, 74b may be configured to analyze the received image data to determine the shape(s) and/or size(s) (e.g., the width(s)) the imaged spray fan(s) 48. Additionally, the respective spray quality controllers 74a, 74b may be configured to analyze the received image data to determine the size of the droplets or particles forms the imaged spray fan(s) 48.

In some embodiments, in addition to each of the spray quality controllers 74a, 74b receiving data from each respective sensor, the spray quality controllers 74a, 74b may also receive information from the other spray quality controllers 74a, 74b and/or from any other system of the vehicle 10, such as the positioning system 70, the weather station 72, the powertrain control system 82, and/or the steering system 90. Additionally, or alternatively, in some embodiments, the vehicle 10 may be equipped with an overlap control system 96 and/or an object detection spray system 98 that can also provide information to the spray quality controllers 74a, 74b. In embodiments including an overlap control system 96, the system may be configured to regulate each of the first and second flow regulators 94a, 94b based on a location of the nozzle 30a, 30b to minimize overlapping application of the agricultural product.

The object detection spray system 98 may utilize the sensors operably coupled with the first and second nozzles 30a, 30b (and/or any other sensor on the vehicle 10 or boom assembly 28) to detect an object within the fan 48 of a specific nozzle 30a, 30b. In various examples, the object may be a weed (or other unwanted growth) such that the flow regulator 94a, 94b may be actuated to apply and/or not apply the agricultural product to the object based on the detected object, which may consider the location, type, population, and/or maturity of the weed. Likewise, in some embodiments, the detected object may be a crop in which the agricultural product is to be applied thereto (or not to be applied thereto). In such instances, the flow regulator 94a, 94b may dispense agricultural product from the appropriate nozzle 30a, 30b at the appropriate times such that the agricultural product is applied to the correct objects.

Based on the detected spray parameters along with the additional information provided by the vehicle controller 60, the spray quality controllers 74a, 74b may be configured to detect whether an appropriate fan 48 is dispensed from each respective nozzle 30a, 30b. For example, the spray quality controller 74a, 74b may be configured to receive flow data from the flow regulator 94a, 94b indicative of a demanded application rate and receive the captured data from the sensor as the agricultural vehicle 10 travels across the field 40. When the flow data from the flow regulator 94a, 94b indicates a flow to the nozzle 30a, 30b and the captured data from the sensor indicates a lack of spray from the nozzle 30a, 30b, the spray quality controller 74a, 74b may generate a malfunction notification to the vehicle controller 60, which in turn may be relayed on to the HMI 22, the notification system 76, and/or the electronic device 78. Conversely, when the flow data from the flow regulator 94a, 94b indicates a flow to the nozzle 30a, 30b has been restricted to prevent an overlapping application, the spray quality controller 74a, 74b may deem that the lack of spray is appropriate and, thus, a proper usage notification can be provided to the vehicle controller 60, which in turn may be relayed on to the HMI 22, the notification system 76, and/or an electronic device 78.

In some embodiments, the spray quality controllers 74a, 74b may each receive a respective flow rate from their respective flow regulator 94a, 94b, a PWM pulse rate from each respective flow regulator 94a, 94b, an orifice type for each respective nozzle 30a, 30b, which may be automatically detect by the sensor and/or manually inputted through the HMI 22 and/or the electronic device 78, an agricultural product formulation, a vehicle speed/direction, and air speed/direction from the weather station 72, and/or boom dynamics (pitch, yaw, roll, vibration, acceleration, etc.). In addition, the spray quality controllers 74a, 74b may also receive information relating to other vehicle systems, such as the overlap control system 96 and/or the object detection spray system 98. Each spray quality controller 74a, 74b may aggregate the information received and determine a spray quality for that nozzle 30a, 30b that is relayed to the vehicle controller 60 for further processing, storage, and/or display to an operator of the vehicle 10. In some instances, the spray quality controller 74a, 74b may receive data indicative of a pulse width falling to zero for one of the nozzles 30a, 30b, which may be due to overlap control by the overlap control system 96 and/or smart spraying control by the object detection spray system 98, and, therefore, the spray quality controller 74a, 74b may determine that the poor spray pattern and flow is not due to blockage, air turbulence, or damage but rather to actuation of an additional system. In such instances, the spray quality controller 74a, 74b can report appropriate function of the nozzle 30a, 30b even while no fan 48 is produced by the nozzle 30a, 30b. Conversely, the spray quality controller 74a, 74b may receive data indicative of a pulse width being greater than zero for one of the nozzles 30a, 30b and that a spray pattern fails to match an intended fan 48 based on deviation of one or more spray quality parameters. In such instances, the spray quality controller 74a, 74b may determine that the poor spray pattern and flow is due to blockage, air turbulence, or damage and can notify the operator that the spray quality has deviated from the intended fan pattern.

In some embodiments, the spray quality controller 74a, 74b may be organized into a network of two or more controllers 74a, 74b that relay the spray quality parameters for respective nozzles 30a, 30b to the vehicle controller 60. In response, the vehicle controller 60 may store the spray quality at geo-located vehicle positions, map the spray quality over a corresponding field map, and/or generate a notification when the spray quality deviates from a predefined range and/or from the demanded application rate.

In some embodiments, the vehicle notification system 76 may prompt visual, auditory, and tactile notifications and/or warnings when one or more nozzles 30a, 30b deviates from a predefined range and/or the spray quality from a specific nozzles 30a, 30b deviates from a predefined range. For instance, vehicle brake lights 100 and/or vehicle emergency flashers may provide a visual alert. A vehicle horn 102 and/or speaker 104 may provide an audible alert. A haptic device 106 integrated into the cab 20 and/or any other location may provide a tactile alert. Additionally, the vehicle controller 60 and/or the vehicle notification system 76 may communicate with the HMI 22 of the vehicle 10. In addition to providing the notification to the operator, the vehicle controller 60 may additionally store the location of the vehicle 10 at the time of the notification. The stored location may be displayed through a field map to illustrate locations of the field 40 in which an agricultural product may have been misapplied.

Further, the system 58 may communicate via wired and/or wireless communication with one or more remote electronic devices 78 through a transceiver 108. The network may be one or more of various wired or wireless communication mechanisms, including any combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary wireless communication networks include a wireless transceiver (e.g., a BLUETOOTH module, a ZIGBEE transceiver, a Wi-Fi transceiver, an IrDA transceiver, an RFID transceiver, etc.), local area networks (LAN), and/or wide area networks (WAN), including the Internet, providing data communication services.

The electronic device 78 may also include a display for displaying information to a user. For instance, the electronic device 78 may display one or more user interfaces and may be capable of receiving remote user inputs to set a predefined threshold for any of the spray quality parameters and/or to input any other information, such as the agricultural product to be used in a spray operation. In addition, the electronic device 78 may provide feedback information, such as visual, audible, and tactile alerts and/or allow the operator to alter or adjust one or more components of the vehicle 10 or the boom assembly 28 through usage of the remote electronic device 78. It will be appreciated that the electronic device 78 may be any one of a variety of computing devices and may include a processor and memory. For example, the electronic device 78 may be a cell phone, mobile communication device, key fob, wearable device (e.g., fitness band, watch, glasses, jewelry, wallet), apparel (e.g., a tee shirt, gloves, shoes or other accessories), personal digital assistant, headphones and/or other devices that include capabilities for wireless communications and/or any wired communications protocols.

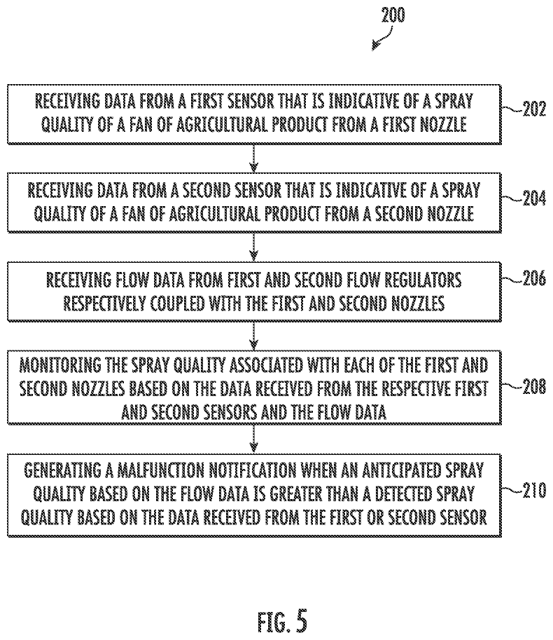

Referring now to FIG. 5, a flow diagram of some embodiments of a method 200 for monitoring an agricultural product during a spray operation using a work vehicle 10 is illustrated in accordance with aspects of the present subject matter. In general, the method 200 will be described herein with reference to the vehicle 10, the boom assembly 28, and the system 58 described above with reference to FIGS. 1-4. However, it should be appreciated by those of ordinary skill in the art that the disclosed method 200 may generally be utilized to monitor one or more spray quality parameters of any suitable applicator associated with any suitable agricultural vehicle 10 and/or may be utilized in connection with a system having any other suitable system configuration. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (202), the method 200 may include receiving data from a first sensor that is indicative of a spray quality of a fan 48 of agricultural product from a first nozzle 30a. Additionally, at (204) the method may include receiving data from a second sensor that is indicative of a spray quality of a fan 48 of agricultural product from a second nozzle 30b. At (206), the method may include receiving flow data from first and second flow regulators 94a, 94b respectively coupled with the first and second nozzles 30a, 30b.

At (208), the method may include monitoring the spray quality associated with each of the first and second nozzles 30a, 30b based on the data received from the respective first and second sensors and the flow data. In response to monitoring, at (210) the method may include generating a malfunction notification when an anticipated spray quality based on the flow data is greater than a detected spray quality based on the data received from the first or second sensor. As provided herein, in some instances, the spray quality may be anticipated to be zero based on the actuation of another vehicle system, such as an overlap control system 96 and/or an object detection spray system 98. Conversely, in some instances, the system may be determined to be malfunctioning when the anticipated spray quality based on the flow data is greater than a detected spray quality. The malfunction may be caused by a blockage, air turbulence, damage to a component of the boom assembly 28 and/or vehicle 10, and/or for any other reason. In some examples, the malfunction notification is provided to an operator of the vehicle 10 as a visual, audible, or haptic notification. Additionally, or alternatively, the malfunction notification may be provided to the operator through a remote electronic device 78.

It is to be understood that the steps of the method 200 is performed by the controller upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller described herein, such as the method 200, is implemented in software code or instructions which are tangibly stored on a tangible computer readable medium. The controller loads the software code or instructions via a direct interface with the computer readable medium or via a wired and/or wireless network. Upon loading and executing such software code or instructions by the controller, the controller may perform any of the functionality of the controller described herein, including any steps of the method 200 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for monitoring spray quality of an agricultural vehicle, the system comprising:
a boom assembly;
a nozzle positioned along the boom assembly;
a flow regulator operably coupled with the nozzle and configured to control a flow of agricultural product through the nozzle;
a sensor configured to capture data indicative of a spray exhausted from the nozzle; and
a spray quality controller communicatively coupled to the sensor, the controller configured to:
receive flow data from the flow regulator indicative of a demanded application rate;
receive the captured data from the sensor as the agricultural vehicle travels across the field; and
generate a malfunction notification when the flow data from the flow regulator indicates a flow to the nozzle and the captured data from the sensor indicates a lack of spray from the nozzle.

2. The system of claim 1, wherein the flow regulator is configured to selectively exhaust the agricultural product from the nozzle based on an overlap control system, the overlap control system configured to minimize duplicative application to a common area of the field.

3. The system of claim 1, wherein the flow regulator is configured to selectively exhaust the agricultural product from the nozzle based on a presence of a weed proximate to a fan of agricultural product exhausted from the nozzle.

4. The system of claim 1, wherein the sensor comprises an imaging device supported on the boom such that a fan of agricultural product being dispensed by the nozzle is positioned within a field of view of the imaging device.

5. The system of claim 1, wherein the spray quality controller is further configured to receive data indicative of a spray quality parameter and calculate a spray quality based off of the spray quality parameter and the captured data from the sensor.

6. The system of claim 5, wherein the spray quality parameter is at least one of an application rate of agricultural product, a pulse width modulation (PWM) pulse rate, a nozzle orifice type, an agricultural product formulation, a vehicle travel speed, a vehicle direction, a weather related variable, or boom movement.

7. The system of claim 1, further comprising:
a positioning system communicatively coupled to a vehicle controller, the vehicle controller being configured to receive location data from the positioning system associated with the boom assembly and correlate the location data to the flow regulator data and the sensor data to generate or update an application field map associated with the field.

8. A boom assembly comprising:
a frame;
a boom arm coupled to the frame;
first and second nozzles positioned along the boom arm, each of the first and second nozzles configured to dispense a fan of an agricultural product therefrom;
a first sensor configured to capture data indicative of a spray quality associated with the dispensed fan of the first nozzle;
a second sensor configured to capture data indicative of a spray quality associated with the dispensed fan of the second nozzle;
a first spray quality controller operably coupled with the first sensor and configured to calculate a first nozzle spray quality; and
a second spray quality controller operably coupled with the second sensor and configured to calculate a second nozzle spray quality, wherein the first and second nozzle spray qualities are independently communicated to a vehicle controller.

9. The boom assembly of claim 8, wherein the vehicle controller is operably coupled with a display and configured to provide a notification on the display when at least one of the first or second spray qualities deviate from a predefined range.

10. The boom assembly of claim 8, wherein both of the first and second spray quality controllers receive vehicle information from the vehicle controller, the vehicle information including at least one of a vehicle speed and a vehicle direction.

11. The boom assembly of claim 8, further comprising:
a first flow regulator operably coupled with the first nozzle and configured to control a flow of agricultural product through the first nozzle; and
a second flow regulator operably coupled with the second nozzle and configured to control a flow of agricultural product through the second nozzle.

12. The boom assembly of claim 11, further comprising:
an overlap control system, wherein the first and second flow regulators selectively inhibit flow through the respective first and second nozzles to minimize duplicative application of the agricultural product.

13. The boom assembly of claim 12, wherein the vehicle controller is operably coupled with a human machine interface (HMI) and the spray quality controller generates a malfunction notification when flow data from the first or second flow regulator indicates a flow to the respective first or second nozzle due to non-duplicative application and the captured data from the respective first or second sensor indicates a lack of spray from the nozzle.

14. The boom assembly of claim 11, further comprising:
a weed detection system, wherein the first and second flow regulators selectively allow flow through the respective first and second nozzles when a predefined weed or predefined concentration of weeds is detected.

15. The boom assembly of claim 14, wherein the vehicle controller is operably coupled with a human machine interface (HMI) and the spray quality controller generates a malfunction notification when flow data from the first or second flow regulator indicates a flow to the respective first or second nozzle due to the detection of the predefined weed and the captured data from the respective first or second sensor indicates a lack of spray from the nozzle.

16. A method for monitoring an agricultural product during a spray operation, the method comprising:
receiving data from a first sensor that is indicative of a spray quality of a fan of agricultural product from a first nozzle;
receiving data from a second sensor that is indicative of a spray quality of a fan of agricultural product from a second nozzle;
receiving flow data from first and second flow regulators respectively coupled with the first and second nozzles;
monitoring, with a computing device, the spray quality associated with each of the first and second nozzles based on the data received from the respective first and second sensors and the flow data; and
generating a malfunction notification when an anticipated spray quality based on the flow data is greater than a detected spray quality based on the data received from the first or second sensor.

17. The method of claim 16, wherein the monitoring the spray quality associated with each of the first and second nozzles based on the data received from the respective first and second sensors and the flow data is accomplished through a vehicle controller that receives a first spray quality from the first sensor from a first spray quality controller and a second spray quality from the second sensor from a second spray quality controller.

18. The method of claim 16, further comprising:
receiving location data associated with the first and second nozzles; and
correlating the location data to the first and second spray qualities to generate or update a field map associated with the field.

19. The method of claim 16, wherein generating a malfunction notification further comprises providing a visual, audible, or haptic notification.

20. The method of claim 16, wherein generating a malfunction notification further comprises providing a notification to a remote electronic device.
